(19) United States
(12) Patent Application Publication
(10) Pub. No.: US 2026/0301391 A1
(43) Pub. Date: Oct. 1, 2026

(54) Method for Training a Machine Learning Algorithm to Assign a Confidence Value to Each of a Plurality of Object Detection Results

(71) Applicant: Robert Bosch GmbH, Stuttgart (DE)

(72) Inventor: Koba Natroshvili, Waldbronn (DE)

(21) Appl. No.: 18/881,361

(22) PCT Filed: Jul. 11, 2023
(86) PCT No.: PCT/EP2023/069120

§ 371 Date: Jan. 6, 2025

(30) Foreign Application Priority Data
Jul. 12, 2022 (DE) 10 2022 207 093.3

(51) Int. Cl. G06V 10/778

(52) U.S. Cl. CPC G06V 10/778

(57) ABSTRACT

A method is for training a machine-learning algorithm to assign a confidence value to each of a plurality of object detection results. The method includes providing training data for training the machine-learning algorithm. The training data includes a plurality of object detection results. The plurality of object detection results respectively denote the same object. Each of the plurality of object detection results is based on a different combination of object detections generated based on sensor data from at least two different sensors, as well as ground truth information regarding the object.

The invention relates to a method for training a machine-learning algorithm to assign a confidence value to each of a plurality of object detection results, wherein the plurality of object detection results respectively denote the same object, and wherein each of the plurality of object detection results is based on a different combination of object detections generated based on sensor data from at least two different sensors.

Common motor vehicles, and in particular autonomously-driving motor vehicles, comprise a plurality of sensors, wherein sensor data may be obtained from these sensors to respectively control vehicle functions, for example a drive component, a vehicle controller, a lighting device, or another controllable system of the respective motor vehicle.

A sensor, which is also referred to as a detector or (measurement) sensor or (measuring) probe, is a technical component that can record certain physical or chemical characteristics and/or the material characteristics of its surroundings qualitatively, or quantitatively as a measured variable.

Sensors integrated in an ordinary motor vehicle can be, for example, optical sensors, in particular lidar sensors, radar sensors, or optical cameras. For example, the data acquired by these sensors may be processed by an object detection algorithm, respectively, to detect objects in the corresponding data or combinations of this data, for example, pedestrians and/or other motor vehicles. Based on the detected objects, one or more vehicle functions may subsequently be controlled, for example, safety-directed actions are initiated.

It should be noted that different sensors have different characteristics and/or are designed for different circumstances. For example, lidar sensors or lidar measurement systems are fast and precise, but are susceptible to dust, water, or smoke particles. Radar sensors, on the other hand, can be optimally utilized regardless of the present weather conditions, wherein radar sensors are in particular also suitable for measuring speeds. Furthermore, optical cameras usually have a very good resolution. Thus, there is a need for methods that enable the objects detected based on sensor data from these sensors to be optimally processed based on current conditions in order to enable the best possible performance.

Publication DE 10 2009 021 785 B 4 discloses a method for object detection, wherein the object has a plurality of abstract object characteristics and is assigned to an object characteristic class of a hierarchical system of object characteristic classes stored in a first memory, wherein at least one location in which the object is presumed to be, by means of a plurality of sensors comprising a sensor community, each responsive to at least one object characteristic and subsequently emitting a sensor signal, is considered, wherein it is checked whether the emitted sensor signals each exceed a threshold value predetermined for them and the sensor signals, which exceed the threshold, are accepted. The sensor characteristics for which accepted sensor signals have been obtained are combined in pairs to form identification characteristic pairs, wherein all of the identification characteristic pairs are compared to object characteristic classes stored in a first memory, and wherein the object is determined from the object characteristic class whose object characteristic pairs are identical to the obtained identification characteristic pairs.

The invention is thus based on the task of specifying a method that allows the objects detected based on sensor data from different sensors to be optimally processed based on current circumstances.

The task is solved by a method for training a machine-learning algorithm to assign a confidence value to each of a plurality of object detection results according to the features of claim 1.

The task is also solved by a control unit for training a machine-learning algorithm to assign a confidence value to each of a plurality of object detection results according to the features of claim 6.

### Disclosure of the Invention

According to one embodiment of the invention, this problem is solved by a method for training a machine-learning algorithm to assign a confidence value to each of a plurality of object detection results, wherein the plurality of object detection results respectively denote the same object, and wherein each of the plurality of object detection results is based on a different combination of object detections generated based on sensor data from at least two different sensors, and wherein the method comprises providing training data for training the machine-learning algorithm, wherein the training data has a plurality of object detection results, wherein the plurality of object detection results respectively denote the same object, and wherein each of the plurality of object detection results is based on a different combination of object detections generated based on sensor data from at least two different sensors, and wherein the training data further comprises ground truth information regarding the object, and training the machine-learning algorithm, wherein the training of the machine-learning algorithm for each of the plurality of object detection results comprises determining a distance between the respective object detection result and the ground truth and assigning a confidence value to the respective object detection result based on the distance between the respective object detection result and the ground truth, for each of the plurality of object detection results, and determining a respective distance to each of the other object detection results, and training the machine-learning algorithm based on the confidence values respectively assigned to the object detection results and the distances between the individual object detection results in such a way that, based on the distances between the plurality of object detection results, conclusions can be made as to the confidence value of each of the plurality of object detection results.

Machine-learning algorithms are based on using statistical methods to train a data processing system so that it can perform a specific task without having been explicitly programmed to do so. The goal of machine learning is to construct algorithms that can learn and make predictions from data. These algorithms create mathematical models with which data can be classified, for example.

Confidence value further refers to an estimation of a model as to the accuracy of individual predicted values of descriptive value, wherein the confidence value is usually between zero and one, and the larger it is, the greater the accuracy.

Ground truth information is also understood to mean knowledge of an accurate position of the corresponding object.

Different sensors are further understood to mean sensors with different characteristics or sensors designed for different circumstances.

Object detection also means detecting objects in data acquired from exactly one of the at least two different sensors by applying an object detection algorithm to the corresponding data.

Object detection result is further understood to mean the combination or fusion of one or more of these object detections to a common object detection result.

If the distance between one of the object detection results and the ground truth information or the exact position of the object is very low, this means that the corresponding object detection result is very accurate. On the other hand, if the distance between one of the object detection results and the ground truth information is comparatively large, this means that the corresponding object detection result is comparatively inaccurate.

Thus, the machine-learning algorithm is trained based on labeled training data, so that it can draw conclusions about a likely actual position of the respective object and thus also the respective distances of the individual object detection results to the actual position of the object based on the distances of the individual object detection results, from which corresponding confidence values and thus also the best sensor, or the best combination of sensors, in the corresponding case can be derived.

Overall, a method is thus specified that allows the objects detected based on different sensors to be optimally processed based on current conditions.

The step of training the machine-learning algorithm may comprise training the machine-learning algorithm in such a way that it is permutational invariant.

The fact that the machine-learning algorithm is permutational invariant means that it remains the same, or is independent of whether individual input data is swapped.

As a result, the assignment, and in particular the accuracy of the assignment of a confidence value to each of a plurality of object detection results, can be further increased.

In addition, the at least two different sensors may be at least two of a lidar sensor, a radar sensor, and an optical camera.

Lidar sensors produce precise, three-dimensional information about the shape and surface characteristics of the surrounding objects. The technology uses laser beams in the range that is safe for eyes to create a 3D image of the detected surroundings. However, it proves to be disadvantageous, for example, that they are susceptible to dust, water or smoke particles.

A radar sensor is a beam-based sensor used to detect objects, for example, other vehicles and pedestrians, and measure their distance to the vehicle and their relative velocities. Electromagnetic waves are transmitted for this purpose. Radar sensors, on the other hand, can be optimally utilized regardless of the present weather conditions, wherein radar sensors are in particular also suitable for measuring speeds.

In an optical camera, light travels through lenses that throw the image onto a sensor and into a camera body. Optical cameras usually have a very good resolution.

The at least two different sensors can thus be sensors that are often found in motor vehicles, for example autonomously driving motor vehicles.

However, the fact that the at least two different sensors are at least two of a lidar sensor, a radar sensor and an optical camera, is only one possible embodiment. Rather, the at least two different sensors may also comprise other sensors, each having different characteristics and/or sensors configured for different circumstances.

In a further embodiment of the invention, a method for detecting an object in sensor data from at least two different sensors is also indicated, wherein the method comprises providing sensor data from at least two different sensors, with the each of the at least two different sensors, each detecting an object in sensor data captured by the respective sensor to obtain object detections, generating a plurality of object detection results from the object detections by fusion of one or more object detections, for each of the plurality of object detection results assigning a respective confidence value to the object detection result by a machine-learning algorithm to assign a confidence value to each of a plurality of object detection results, wherein the machine-learning algorithm for assigning a confidence value to each of a plurality of object detection results has been trained by a method described above for training a machine-learning algorithm to assign a confidence value to each of a plurality of object detection results, comparing the respective confidence values assigned to the plurality of object detection results in order to determine the object detection result with the highest confidence value, and detecting the object based on the object detection result with the highest confidence value.

Thus, a method for detecting an object in sensor data from at least two different sensors is indicated, which is based on a method that allows for the objects detected based on these sensors to be able to be optimally processed based on current conditions, in particular, the method is based on a machine-learning algorithm, which is trained based on labeled training data so that it can draw conclusions about a likely actual position of the respective object and thus also the respective distances of the individual object detection results to the actual position of the object based on the distances of the individual object detection results to one another, from which corresponding confidence values and thus also the best sensor, or the best combination of sensors, in the corresponding case can be derived.

In a further embodiment of the invention, there is also a method provided for controlling a controllable system based on objects detected in sensor data from at least two different sensors, wherein the method comprises detecting an object in sensor data from the at least two different sensors by means of a method described above for detecting an object in sensor data from at least two different sensors, and controlling the controllable system based on the detected object.

A controllable system is understood to mean a system that is controllable such that a state of the system, or of one or more components of the system, can be converted to a new state in finite time by applying suitable control signals or by applying suitable tasks or actions, in particular from a selected input state to a selected output state.

Thus, a method for controlling a controllable system is provided, which is carried out based on a method that allows for the objects detected based on different sensors to be optimally processed based on current conditions, and the method is particularly based on a machine-learning algorithm that is trained based on labeled training data, so that it can draw conclusions about a likely actual position of the respective object and thus also the respective distances of the individual object detection results to the actual position of the object based on the distances of the individual object detection results, from which corresponding confidence values and thus also the best sensor, or the best combination of sensors, in the corresponding case can be derived.

The controllable system can in particular be a robotic system and, for example, an autonomously driving motor vehicle.

In an additional embodiment of the invention, a control device is also indicated for training a machine-learning algorithm to assign a confidence value to each of a plurality of object detection results, wherein the plurality of object detection results respectively denote the same object, and wherein each of the plurality of object detection results is based on a different combination of object detections generated based on sensor data from at least two different sensors, and wherein the control device comprises a supply unit, which is designed to provide training data for training the machine-learning algorithm, wherein the training data has a plurality of object detection results, wherein the plurality of object detection results respectively denote the same object, and wherein each of the plurality of object detection results is based on a different combination of object detections generated based on sensor data from at least two different sensors, and wherein the training data further comprises ground truth information regarding the object, and training the machine-learning algorithm, wherein the training of the machine-learning algorithm for each of the plurality of object detection results comprises determining a distance between the respective object detection result and the ground truth and assigning a confidence value to the respective object detection result based on the distance between the respective object detection result and the ground truth, for each of the plurality of object detection results, and determining a respective distance to each of the other object detection results, and training the machine-learning algorithm based on the confidence values respectively assigned to the object detection results and the distances between the individual object detection results in such a way that, based on the distances between the plurality of object detection results, conclusions can be made as to the confidence value of each of the plurality of object detection results.

A control unit is thus indicated, which allows the objects detected based on different sensors to be optimally processed based on current conditions. In particular, the control device is designed to train a machine-learning algorithm based on labeled training data, so that it can draw conclusions about a likely actual position of the respective object and thus also the respective distances of the individual object detection results to the actual position of the object based on the distances of the individual object detection results, from which corresponding confidence values and thus also the best sensor, or the best combination of sensors, in the corresponding case can be derived.

The training unit may be configured to train the machine-learning algorithm to be permutational invariant. As a result, the assignment, and in particular the accuracy of the assignment of a confidence value to each of a plurality of object detection results, can be further increased.

In addition, the at least two different sensors may in turn be at least two of a lidar sensor, a radar sensor, and an optical camera. The at least two different sensors can thus be sensors that are often found in motor vehicles, for example autonomously driving motor vehicles.

However, the fact that the at least two different sensors are at least two of a lidar sensor, a radar sensor and an optical camera, is only one possible embodiment. Rather, the at least two different sensors may also comprise other sensors, each having different characteristics and/or sensors configured for different circumstances.

In a further embodiment of the invention, a control device is also indicated for detecting an object in sensor data from at least two different sensors, wherein the control device comprises a supply unit that is designed to provide sensor data from at least two different sensors, a detecting unit that is designed to detect an object in sensor data captured by the respective sensor to obtain object detections for each of the at least two different sensors, a generation unit that is designed to generate a plurality of object detection results from the object detections by fusion of one or more object detections, an assignment unit that is designed to assign a respective confidence value to the object detection result by a machine-learning algorithm for assigning a confidence value to each of a plurality of object detection results for each of the plurality of object detection results, wherein the machine-learning algorithm for assigning a confidence value to each of a plurality of object detection results has been trained by a control device described above for training a machine-learning algorithm to assign a confidence value to each of a plurality of object detection results, a comparison unit that is designed to compare the respective confidence values assigned to the plurality of object detection results in order to determine the object detection result with the highest confidence value, and a determination unit that is designed to detect the object based on the object detection result with the highest confidence value.

Thus, a control device for detecting an object in sensor data from at least two different sensors is indicated, which control device allows for the objects detected based on these sensors to be able to be optimally processed based on current conditions, in particular, the control device is based on a machine-learning algorithm, which is trained based on labeled training data so that it can draw conclusions about a likely actual position of the respective object and thus also the respective distances of the individual object detection results to the actual position of the object based on the distances of the individual object detection results to one another, from which corresponding confidence values and thus also the best sensor, or the best combination of sensors, in the corresponding case can be derived.

In further embodiment of the invention, there is also a control unit provided for controlling a controllable system based on objects detected in sensor data from at least two different sensors, wherein the control device comprises a detection unit that is designed to detect an object in sensor data from the at least two different sensors by means of a control device described above for detecting an object in sensor data from at least two different sensors, and a control device that is designed to control the controllable system based on the detected object.

A control unit is thus indicated for controlling a controllable system that is based on a control device, which allows the objects detected based on these sensors to be optimally processed based on current conditions. In particular, the control device is based on a machine-learning algorithm that is trained based on labeled training data, so that it can draw conclusions about a likely actual position of the respective object and thus also the respective distances of the individual object detection results to the actual position of the object based on the distances of the individual object detection results, from which corresponding confidence values and thus also the best sensor, or the best combination of sensors, in the corresponding case can be derived.

The controllable system can in particular once again be a robotic system and, for example, an autonomously driving motor vehicle.

The described embodiments and further developments may be combined with one another as desired.

Further possible configurations, refinements, and implementations of the invention also comprise not explicitly mentioned combinations of features of the invention described above or below with respect to exemplary embodiments.

### BRIEF DESCRIPTION OF THE DRAWINGS

The accompanying drawings are intended to provide a better understanding of the embodiments of the invention. They illustrate embodiments and, in connection with the description, serve to explain principles and concepts of the invention.

Other embodiments and many of the mentioned advantages become apparent from the drawings. The illustrated elements of the drawings are not necessarily shown to scale with respect to one another.

The figures show:

FIG. 1 shows a flowchart of a method for training a machine-learning algorithm to assign a confidence value to each of a plurality of object detection results according to embodiments of the invention; and

FIG. 2 shows a schematic block diagram of a system for detecting an object in sensor data from at least two different sensors according to embodiments of the invention.

In the figures of the drawings, identical reference numbers denote identical or functionally identical elements, parts or components, unless stated otherwise.

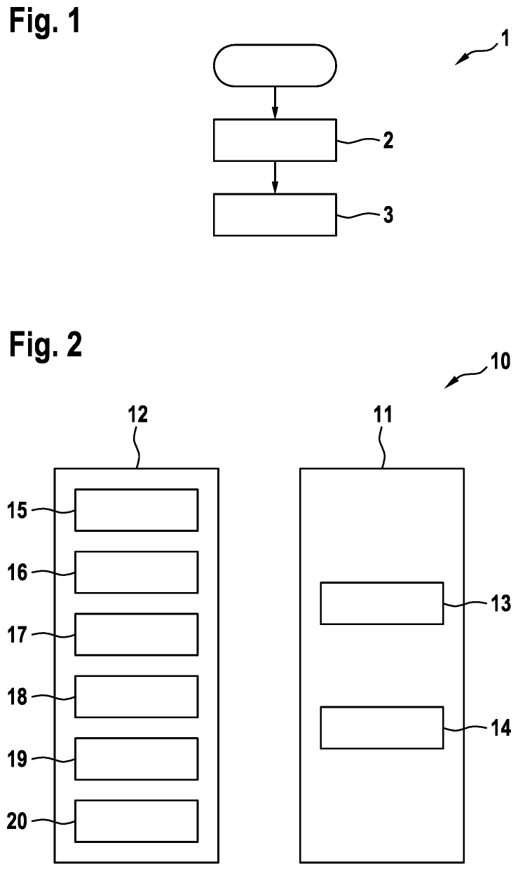

FIG. 1 shows a flow chart of a method for training a machine-learning algorithm to assign a confidence value to each of a plurality of object detection results 1 according to embodiments of the invention.

The sensor data acquired by different sensors, that is, with different characteristics and/or designed for different circumstances, can be fused or linked to obtain better quality information. It is known to fuse sensor data and subsequently further process the fused sensor data. In addition, the data acquired by the individual sensors can be evaluated first and the corresponding evaluation results can then be linked to each other. Such a linking of evaluation results is used, for example in the area of autonomous driving, wherein redundancies are taken into account in the control of corresponding vehicle functions for safety reasons.

However, the fusion results may be affected by impairments or deterioration of the state of one of the sensors, which can lead to safety-critical situations in the analysis of the corresponding data. In particular, impairments or deterioration of the state of one of the sensors also affect the corresponding combinations or modalities. As a result, there is a need for methods to determine the most trustworthy modality.

FIG. 1 shows a method for training a machine-learning algorithm to assign a confidence value to each of a plurality of object detection results 1, wherein the plurality of object detection results respectively denote the same object, and wherein each of the plurality of object detection results is based on a different combination of object detections generated based on sensor data from at least two different sensors, and wherein the method 1 comprises a step 2 providing training data for training the machine-learning algorithm, wherein the training data has a plurality of object detection results, wherein the plurality of object detection results respectively denote the same object, and wherein each of the plurality of object detection results is based on a different combination of object detections generated based on sensor data from at least two different sensors, and wherein the training data further comprises ground truth information regarding the object, and a step 3 training the machine-learning algorithm, wherein the training of the machine-learning algorithm for each of the plurality of object detection results comprises determining a distance between the respective object detection result and the ground truth and assigning a confidence value to the respective object detection result based on the distance between the respective object detection result and the ground truth, for each of the plurality of object detection results, and determining a respective distance to each of the other object detection results, and training the machine-learning algorithm based on the confidence values respectively assigned to the object detection results and the distances between the individual object detection results in such a way that, based on the distances between the plurality of object detection results, conclusions can be made as to the confidence value of each of the plurality of object detection results.

Thus, the machine-learning algorithm is trained based on labeled training data, so that it can draw conclusions about a likely actual position of the respective object and thus also the respective distances of the individual object detection results to the actual position of the object based on the distances of the individual object detection results, from which corresponding confidence values and the best sensor, or the best combination of sensors, in the corresponding case can be derived.

Overall, a method 1 is thus specified that allows the objects detected based on different sensors to be optimally processed based on current conditions.

The distances can each be determined based on, for example, the Mahalanobis distance.

The distances can also further be determined based on characteristics of the respective object derived from the sensor data, for example a position of the respective object and, optionally, dimensions of the object and/or an orientation or inclination of the object and/or an object class.

In addition, a 3D tensor may be generated based on the method, wherein a first dimension of said tensor consists of vectors, the elements of which each denote the distances for one of the sensor modalities. If a distance cannot be determined in one case, the corresponding vector element can be selected or set to a maximum size.

The machine-learning algorithm can further be, for example, an artificial neural network, which receives this tensor as an input.

According to the embodiments of FIG. 1, step 3 of training the machine-learning algorithm comprises training the machine-learning algorithm such that it is permutational invariant.

In particular, the machine-learning algorithm may be trained based on a max-pooling process.

According to the embodiments of FIG. 1, the at least two different sensors are further a lidar sensor, a radar sensor and an optical camera.

The individual modalities are in particular an object detection based on the sensor data of the lidar sensor alone, a combination, or fusion, of an object detection based on the sensor data of the lidar sensor and an object detection based on the sensor data of the radar sensor, a combination of an object detection based on the sensor data of the lidar sensor and an object detection based on the sensor data of the optical camera, a combination of object detection based on the sensor data of the lidar sensor, an object detection based on the sensor data of the radar sensor and an object detection based on the sensor data of the optical camera, an object detection alone based on the sensor data of the radar sensor, a combination of an object detection based on the sensor data of the radar sensor and an object detection based on the sensor data of the lidar sensor, a combination of an object detection based on the sensor data of the radar sensor and an object detection based on the sensor data of the optical camera, a combination of an object detection based on the sensor data of the radar sensor, an object detection based on the sensor data of the lidar sensor and an object detection based on the sensor data of the optical camera, an object detection alone based on the sensor data of the optical camera, a combination of an object detection based on the sensor data of the optical camera and an object detection based on the sensor data of the lidar sensor, a combination of an object detection based on the sensor data of the optical camera and an object detection based on the sensor data of the radar sensor, and a combination of object detection based on the sensor data of the optical camera, an object detection based on the sensor data of the lidar sensor and an object detection based on the sensor data of the radar sensor.

An object detection result with the highest confidence value or a most-trusted object detection result can then be determined, wherein the object can be detected or determined based on the most-trusted object detection result.

The particular object may subsequently be used, in particular, to control a controllable system, for example, an autonomously driving motor vehicle.

FIG. 2 shows a schematic block diagram of a system for detecting an object in sensor data from at least two different sensors 10 according to embodiments of the invention.

As FIG. 2 shows, the system 10 comprises a control device for training a machine-learning algorithm for assigning a confidence value to each of a plurality of object detection results 11 and a control device for detecting an object in sensor data from at least two different sensors 12, wherein the control device is designed to detect an object in sensor data from at least two different sensors 12, detect the object based on a machine-learning algorithm trained by the control device for training an algorithm of assigning a confidence value to each of a plurality of object detection results 11.

According to the embodiments in FIG. 2, the control device for training a machine-learning algorithm to assign a confidence value to each of a plurality of object detection results 11 further comprises a supply unit 13 that is designed to provide training data for training the machine-learning algorithm, wherein the training data has a plurality of object detection results, wherein the plurality of object detection results respectively denote the same object, and wherein each of the plurality of object detection results is based on a different combination of object detections generated based on sensor data from at least two different sensors, and wherein the training data further comprises ground truth information regarding the object, and a training unit 14 that is designed to train the machine-learning algorithm, wherein the training of the machine-learning algorithm for each of the plurality of object detection results comprises determining a distance between the respective object detection result and the ground truth and assigning a confidence value to the respective object detection result based on the distance between the respective object detection result and the ground truth, for each of the plurality of object detection results, and determining a respective distance to each of the other object detection results, and training the machine-learning algorithm based on the confidence values respectively assigned to the object detection results and the distances between the individual object detection results in such a way that, based on the distances between the plurality of object detection results, conclusions can be made as to the confidence value of each of the plurality of object detection results.

The supply unit can be a receiver, for example, which is designed to receive the corresponding data. The training unit may furthermore be implemented, for example, based on code that is stored in a memory and can be executed by a processor.

According to the embodiments of FIG. 2, the training unit 14 is again designed to train the machine-learning algorithm to be permutational invariant.

In addition, the at least two different sensors are in turn at least two of a lidar sensor, a radar sensor and an optical camera.

According to the embodiments of FIG. 2, the control device for detecting an object in sensor data from at least two different sensors 12 further comprises a supply unit 15 that is designed to provide sensor data from at least two different sensors, a detecting unit 16 that is designed to detect an object in sensor data captured by the respective sensor to obtain object detections for each of the at least two different sensors, a generation unit 17 that is designed to generate a plurality of object detection results from the object detections by fusion of one or more object detections, an assignment unit 18 that is designed to assign a respective confidence value to the object detection result by a machine-learning algorithm for assigning a confidence value to each of a plurality of object detection results for each of the plurality of object detection results, wherein the machine-learning algorithm for assigning a confidence value to each of a plurality of object detection results has been trained by the control device for training a machine-learning algorithm to assign a confidence value to each of a plurality of object detection results 11, a comparison unit 19 that is designed to compare the respective confidence values assigned to the plurality of object detection results in order to determine the object detection result with the highest confidence value, and a determination unit 20 that is designed to detect the object based on the object detection result with the highest confidence value.

The supply unit can be a receiver, for example, which is designed to receive the corresponding data. The detection unit, the generation unit, the assignment unit, the comparison unit and the determination unit can further be realized, for example, based on code stored in memory that can be executed by a processor.

In addition, the control device for detecting an object in sensor data from at least two different sensors 12 can also be configured to detect and evaluate multiple objects in a corresponding scene simultaneously.

In addition, the control device for training a machine-learning algorithm to respectively assign a confidence value to each of a plurality of object detection results 11, can in particular be further designed to execute a method described above to training a machine-learning algorithm to respectively assign a confidence value to each of a plurality of object detection results.

1. A method for training a machine-learning algorithm to assign a confidence value to each of a plurality of object detection results, the method comprising:
providing training data for training the machine-learning algorithm, wherein the training data comprises a plurality of object detection results, wherein the plurality of object detection results respectively denote a same object, and wherein each of the plurality of object detection results is based on a different combination of object detections generated based on sensor data from at least two different sensors, and ground truth information regarding the object; and
training the machine-learning algorithm, wherein the training of the machine-learning algorithm for each of the plurality of object detection results comprises:
determining a distance between the respective object detection result and the ground truth and assigning a confidence value to the respective object detection result based on the distance between the respective object detection result and the ground truth, for each of the plurality of object detection results,
determining a respective distance to each of the other object detection results, and
training the machine-learning algorithm based on the confidence values respectively assigned to the object detection results and the distances between the individual object detection results, so that conclusions about the confidence value of each of the plurality of object detection results can be made based on the distances between the plurality of object detection results.

2. The method according to claim 1, wherein training the machine-learning algorithm further comprises training the machine-learning algorithm such that it is permutational invariant.

3. The method according to claim 1, wherein the at least two different sensors are at least two of a lidar sensor, a radar sensor, and an optical camera.

4. A method for detecting an object in sensor data from at least two different sensors, the method comprising:
providing sensor data from at least two different sensors;
for each of the at least two different sensors, detecting an object in sensor data from the respective sensor to obtain object detections;
generating a plurality of object detection results from the object detections by means of fusion of one or more object detections;
for each of the plurality of object detection results, respectively assigning a confidence value to the corresponding object detection result by a machine-learning algorithm for assigning a confidence value to each of a plurality of object detection results, wherein the machine-learning algorithm for assigning a confidence value to each of a plurality of object detection results has been trained by a method for training a machine-learning algorithm to assign a confidence value to each of a plurality of object detection results according to claim 1;
comparing the respective confidence values assigned to the plurality of object detection results to determine the object detection result with a the highest confidence value; and
detecting the object based on the object detection result with the highest confidence value.

5. A method for controlling controllable system based on objects detected in sensor data from at least two different sensors, the method comprising:
detecting an object in sensor data from the at least two different sensors using the method for detecting an object in sensor data from at least two different sensors according to claim 4; and
controlling the controllable system based on the detected object.

6. A control device for training a machine-learning algorithm to assign a confidence value to each of a plurality of object detection results, and the control device comprising:
a supply unit configured to provide training data for training the machine-learning algorithm, wherein the training data has a plurality of object detection results, wherein the plurality of object detection results respectively denote a same object, and wherein each of the plurality of object detection results is based on a different combination of generated object detections based on sensor data from at least two different sensors, and wherein the training data further comprise ground truth information regarding the object; and
a training unit configured to train the machine-learning algorithm, wherein the training of the machine-learning algorithm for each of the plurality of object detection results comprises determining a distance between the respective object detection result and the ground truth and assigning a confidence value to the respective object detection result based on the distance between the respective object detection result and the ground truth, for each of the plurality of object detection results, and determining a respective distance to each of the other object detection results, and training the machine-learning algorithm based on the confidence values respectively assigned to the object detection results and the distances between the individual object detection results in such a way that, based on the distances between the plurality of object detection results, conclusions can be made as to the confidence value of each of the plurality of object detection results.

7. The control device according to claim 6, wherein the training unit is configured to train the machine-learning algorithm such that it is permutational invariant.

8. The control device according to claim 6, wherein the at least two different sensors are at least two of a lidar sensor, a radar sensor, and an optical camera.

9. A control device for detecting an object in sensor data from at least two different sensors, the control device comprising:
a supply unit configured to provide sensor data from at least two different sensors;
a detecting unit configured to detect an object in sensor data captured by the respective sensor to obtain object detections for each of the at least two different sensors;
a generation unit configured to generate a plurality of object detection results from the object detections by fusion of one or more object detections;
an assignment unit configured to assign a respective confidence value to the object detection result by a machine-learning algorithm for assigning a confidence value to each of a plurality of object detection results for each of the plurality of object detection results, wherein the machine-learning algorithm for assigning a confidence value to each of a plurality of object detection results has been trained by the control device for training a machine-learning algorithm to assign a confidence value to each of a plurality of object detection results according to claim 6;
a comparison unit configured to compare the respective confidence values assigned to the plurality of object detection results in order to determine the object detection result with a highest confidence value; and
a determination unit configured to detect the object based on the object detection result with the highest confidence value.

10. A control unit for controlling a controllable system based on objects detected in sensor data from at least two different sensors, the control unit comprising:
a detection unit configured to detect an object in sensor data from the at least two different sensors generated data by a control device for detecting an object in sensor data from at least two different sensors according to claim 9; and
a control device configured to control the controllable system based on the detected object.
